(19) United States
(12) Patent Application Publication
(10) Pub. No.: US 2024/0331083 A1
(43) Pub. Date: Oct. 3, 2024

(54) METHODS, SYSTEMS, APPARATUS, AND ARTICLES OF MANUFACTURE TO DELIVER IMMERSIVE VIDEOS

(71) Applicant: Intel Corporation, Santa Clara, CA (US)

(72) Inventors: Ronald Tadao Azuma, San Jose, CA (US); Horst Werner Haussecker, Palo Alto, CA (US)

(21) Appl. No.: 18/193,991

(22) Filed: Mar. 31, 2023

(51) Int. Cl. G06T 3/00; G06F 3/01; G06F 3/0346; G06T 19/00; H04L 65/1089; H04L 65/80

(52) U.S. Cl. CPC G06T 3/16; G06F 3/011; G06F 3/0346; G06T 19/003; H04L 65/1089; H04L 65/80

(57) ABSTRACT

Methods, systems, apparatus, and articles of manufacture to produce immersive videos are disclosed. An example apparatus includes programmable circuitry to access a first video stream corresponding to a scene, the first video stream including a first video frame, the first video frame including a first tile representative of the scene from a first viewpoint and a second tile representative of the scene from a second viewpoint different from the first viewpoint, access a second video stream corresponding to the scene, the first video stream including a second video frame, the second video frame including a third tile representative of the scene from a third viewpoint and a fourth tile representative of the scene from a fourth viewpoint different from the third viewpoint, and select at least one of the first tile, the second tile, the third tile, or the fourth tile for presentation by a device.

### FIELD OF THE DISCLOSURE

This disclosure relates generally to video processing and, more particularly, to methods, systems, apparatus, and articles of manufacture to deliver immersive videos.

### BACKGROUND

Images from a video stream can be output for presentation by an electronic device. In some instances, the images can be representative of a same scene from different viewpoints, and different ones of the images can be output for presentation as an immersive video to simulate a three-dimensional (3D) scene for a user.

### BRIEF DESCRIPTION OF THE DRAWINGS

FIG. 1 illustrates an example system including example video selection circuitry to produce immersive videos in accordance with teachings of this disclosure.

FIG. 2 is a block diagram of the example video selection circuitry of FIG. 1.

FIG. 3 illustrates selection of an example subset of video streams to be provided to an example device from an example server.

FIG. 4 illustrates switching and/or selection of an example active video stream and example inactive video streams from the example video streams of FIGS. 1 and/or 3.

FIG. 5 is a flowchart representative of example machine readable instructions and/or example operations that may be executed, instantiated, and/or performed by example programmable circuitry to implement the video selection circuitry of FIG. 2.

FIG. 6 is a flowchart representative of example machine readable instructions and/or example operations that may be executed, instantiated, and/or performed by example programmable circuitry to implement the video selection circuitry of FIG. 2 to select new video streams.

FIG. 7 is a block diagram of an example processing platform including programmable circuitry structured to execute, instantiate, and/or perform the example machine readable instructions and/or perform the example operations of FIGS. 5 and/or 6 to implement the video selection circuitry 102 of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 5 and/or 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Examples disclosed herein relate to immersive media applications, including those implementing augmented reality (AR) and/or virtual reality (VR), in which image data representing a scene (e.g., a 360-degree scene) may be generated by combining images and/or videos from multiple camera perspectives. An electronic user device (also referred to herein as a device or a user device) such as a laptop, a tablet, or a smartphone can include a display to present the images and/or videos to a user of the device. Different types of media have the ability to convey depth information to a user and improve user experience when viewing the video. For instance, immersive video (e.g., variable viewpoint video) is a form of media in which a user can change a viewpoint of a scene represented in the video. Changing the viewpoint at which the scene is presented activates a depth cue (e.g., motion parallax) that enables the user to better understand 3D content of the scene. Accordingly, immersive video can improve user experience for applications such as livestreaming, instructional videos on demand, teleconferencing, etc.

Immersive videos can be generated based on multiple synchronized video streams from multiple cameras capturing a same 3D scene from different viewpoints. In some examples, images (e.g., frames) from the multiple video streams are provided as input to one or more algorithms, and the algorithms are executed to synthesize photorealistic new images representative of the 3D scene from intermediate viewpoints (e.g., viewpoints at which no camera existed).

Examples disclosed herein utilize a combined (e.g., hybrid) switching and tiling technique to produce immersive videos. In examples disclosed herein, switching refers to producing an immersive video by selecting a video stream from multiple video streams capturing a same 3D scene from different viewpoints. In some such examples, the viewpoint of the scene represented in the immersive video can be adjusted by switching between the multiple video streams. In examples disclosed herein, tiling refers to producing an immersive video by combining multiple synchronized images (e.g., frames) from the multiple video streams into a single frame, where each of the synchronized images corresponds to a tile (e.g., a portion) of the frame. In some such examples, the viewpoint of the scene represented in the immersive video can be adjusted by selecting different one(s) of the tiles to be enlarged and/or output for presentation.

In examples disclosed herein, example video selection circuitry accesses multiple synchronized video streams corresponding to a scene, where frames of the video streams include multiple tiles (e.g., sub-images) representative of the scene from different viewpoints. In some examples, the video selection circuitry accesses the multiple video streams in response to navigation of a device (e.g., a user device, an electronic device) to a web page via a web browser. The video selection circuitry selects, based on user input and/or based on a position and/or orientation of a user of the device, one of the viewpoints to be presented to the user. In some examples, the video selection circuitry selects one of the tiles corresponding to the selected viewpoint, and causes the web browser to present the one of the tiles on the web page as an immersive video. In some examples, the video stream corresponding to the selected tile is identified as an active video stream, and remaining ones of the video streams are identified as inactive (e.g., background) video streams. In some such examples, the video selection circuitry switches one or more of the inactive video streams to be accessed from the server(s) based on one or more criteria (e.g., whether the inactive video streams are in a neighborhood of the active video stream).

In some examples, ones of the tiles included in the video streams have an HD resolution (e.g., at least 1280×720 pixels), such that the immersive video output based on one of the tiles is an HD immersive video. A relatively small number of the viewpoints may be represented per video stream in examples disclosed herein. Examples disclosed herein enable switching between multiple tiled video streams to provide a larger number of different viewpoints of a scene. Including the small number of the tiles per video stream reduces the bandwidth required to access one(s) of the video streams. Therefore, examples disclosed herein advantageously produce HD immersive videos while reducing bandwidth utilization. In particular, examples disclosed herein enable streaming of HD immersive videos via a web browser using bandwidth of 50 Mbps or less. Additionally, by switching between multiple tiled video streams available at the device level, examples disclosed herein reduce delays associated with switching between different video streams at the server level. As such, examples disclosed herein prevent and/or reduce pausing and/or lagging of immersive videos streamed via the web browser.

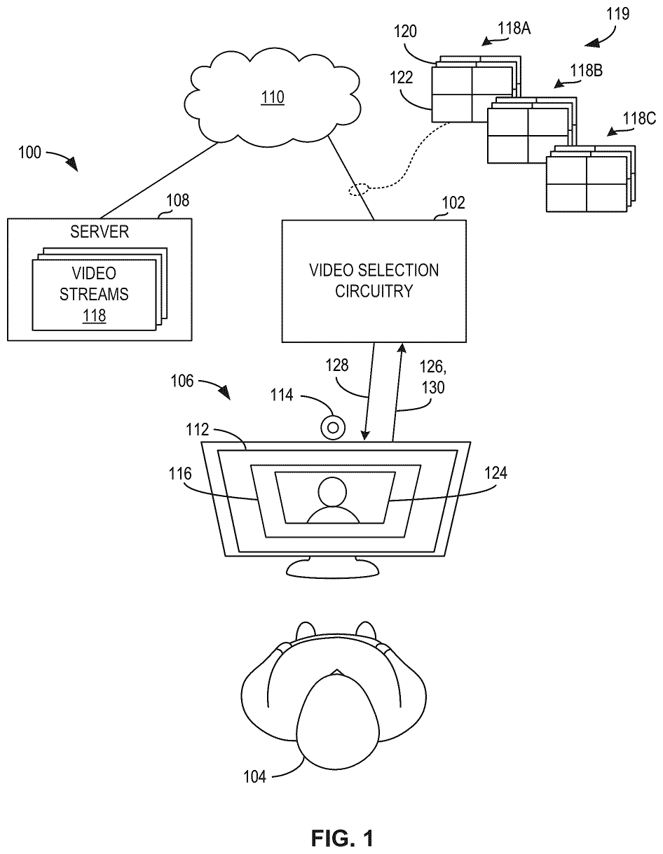

FIG. 1 illustrates an example system 100 including example video selection circuitry 102 to control presentation of immersive videos to an example user 104 in accordance with teachings of this disclosure. In some examples, the video selection circuitry 102 utilizes a combined switching and tiling technique to generate HD immersive videos using download speeds commonly available for a website browser. In the illustrated example of FIG. 1, the video selection circuitry 102 is implemented by an example device (e.g., an electronic device, a client device) 106. In some examples, the video selection circuitry 102 may be implemented by one or more example cloud-based devices and/or other user devices (e.g., a smartphone). In this example, the video selection circuitry 102 is communicatively coupled to an example server 108 via an example network 110.

The device 106 of FIG. 1 can include, for instance, personal computing device such as a desktop computer. The device 106 can include other types of user devices, such as a laptop, a smartphone, an electronic tablet, etc. In some examples, the device 106 is a virtual reality device, an augmented reality device, a mixed reality device, etc. In the illustrated example, the device 106 includes an example display 112 (e.g., a display screen) and an example camera 114. In some examples, the camera 114 is a built-in camera of the device 106. In some examples, the camera 114 is an accessory that can be coupled to (e.g., mounted to) the device 106. In the example of FIG. 1, the camera 114 is a video camera. In some examples, the video selection circuitry 102 is communicatively coupled to the camera 114 to obtain image data (e.g., video stream data) captured by the camera 114.

The device 106 of FIG. 1 allows the user 104 to access a web page via an example browser (e.g., a web browser) 116. For example, the browser 116 requests the web page from the server 108, and accesses code (e.g., Hypertext Markup Language (HTML) code, Cascading Style Sheets (CSS) code, JavaScript code, etc.) corresponding to the requested web page from the server 108. In some examples, as a result of execution of the code by the browser 116, the video selection circuitry 102 accesses and/or retrieves one or more example video streams 118 from the server 108 and/or from one or more other servers communicatively coupled to the video selection circuitry 102 via the network 110. For example, the video selection circuitry 102 selects an example subset 119 of the video streams 118 to be retrieved and/or downloaded from the server 108, where the subset 119 includes a first example video stream 118A, a second example video stream 118B, and a third example video stream 118C in this example. In some examples, a different number of the video streams 118 can be included in the subset 119. Although examples disclosed herein are discussed in connection with the video streams, examples disclosed herein could additionally or alternatively be used in connection with other types of image data, such as still images.

In the illustrated example of FIG. 1, the video streams 118 are provided to the video selection circuitry 102 as corresponding example frames (e.g., tiled images, video frames) 120 representing a scene at different points in time. In some examples, the frames 120 are provided at a frame rate of 30 frames per second (fps). In some examples, the frames 120 can be provided at a different frame rate (e.g., less than 30 fps, greater than 30 fps). In the illustrated example of FIG. 1, one(s) of the example frames 120 are divided into example tiles (e.g., sub-images) 122 corresponding to different portions of the respective frames 120. In this example, ones of the frames 120 include four of the tiles 122 in a 2-by-2 configuration, where the frames 120 have a resolution of 2560×1440 pixels and the tiles 122 have a resolution of 1280×720 pixels. In some examples, a number of the tiles 122 per frame 120, a configuration of the tiles 122, the resolution of the tiles 122, and/or the resolution frame 120 can be different. In this example, a bandwidth utilized to access and/or stream each of the video streams 118 via the web browser 116 is 10 Mbps, such that a total bandwidth utilized to stream the three video streams 118A, 118B, 118C is approximately 30 Mbps.

In the example of FIG. 1, the tiles 122 are representative of the scene from different viewpoints. For example, when eleven of the video streams 118 are available from the server 108, and each of the video streams 118 includes four of the tiles 122, a total of 44 viewpoints are available for presentation to the user 104. In some examples, a number of the video streams 118 and/or the number of tiles 122 per video stream 118 can be different, such that a total number of viewpoints can be greater or less than 44. In this example, the viewpoints are at different angular positions (e.g., yaw, pitch, and/or roll) relative to the scene, and the angular position gradually varies across a sequence of the viewpoints from a first angular position (e.g., a first threshold viewpoint) to a second angular position (e.g., a second threshold viewpoint). In some examples, tile numbers are assigned to corresponding ones of the tiles 122, where the tile numbers indicate the sequence of viewpoints across the tiles 122 from the first angular position to the second angular position.

In some examples, the tiles 122 are assigned to and/or used to generate the respective video streams 118 based on the tile numbers. For example, the first video stream 118A can include a first set of the tiles 122 corresponding to tile numbers 0 through 3, the second video stream 118B can include a second set of the tiles 122 corresponding to tile numbers 4 through 7, the third video stream 118C can include a third set of the tiles 122 corresponding to tile numbers 8 through 11, etc. Further, in some examples, stream numbers are assigned to the video streams 118 based on the sequence of the tiles 122 included therein. For example, the first video stream 118A corresponding to the tile numbers 0 through 3 is labeled stream number 1, the second video stream 118B corresponding to the tile numbers 4 through 7 is labeled stream number 2, the third video stream 118C corresponding to the tile numbers 8 through 11 is labeled stream number 3, etc. While numbers are used to indicate a position and/or sequence of the tiles 122 and/or the video streams 118 in this example, a different notation (e.g., letters, symbols, etc.) may be used instead.

In the illustrated example of FIG. 1, the video selection circuitry 102 causes the device 106 to present an example immersive video 124 in the browser 116 by selecting one(s) of the video streams 118 and/or the tiles 122 for presentation. In some examples, the video selection circuitry 102 selects the one(s) of the video streams 118 and/or the tiles 122 based on user input. For example, the user 104 can provide user input to the device 106 via one or more input devices (e.g., a keyboard, a mouse, etc.) operatively coupled to the device 106. In some examples, the user 104 can select a viewpoint of the immersive video 124 to be presented based on the user input, where the user input can include adjusting a slider presented on a web page, using the mouse to click and/or drag different portions of the immersive video 124, etc. In some examples, example user input data 126 is provided to the video selection circuitry 102, and the video selection circuitry 102 determines a selected viewpoint based on the user input data 126. In such examples, the video selection circuitry 102 identifies and/or selects an example output tile 128 from the tiles 122 in the subset 119 of video streams 118, where the output tile 128 corresponds to the selected viewpoint. In some examples, the video selection circuitry 102 provides the output tile 128 to the browser 116 for presentation, where the output tile 128 corresponds to the immersive video 124 presented by the browser 116.

In some examples, the video selection circuitry 102 identifies and/or selects the output tile 128 based on a position and/or orientation of the user 104 relative to the device 106 and/or the camera 114. For example, the camera 114 captures images of the user 104 and provides the images as an example camera stream (e.g., a camera image stream) 130 to the video selection circuitry 102. In some examples, the video selection circuitry 102 analyzes the images from the camera stream 130 based on one or more image processing techniques and/or machine learning algorithms to determine the position and/or orientation (e.g., yaw, pitch, and/or roll) of the user 104 relative to the device 106 and/or the camera 114. In some examples, the video selection circuitry 102 identifies a viewpoint corresponding to the position and/or orientation of the user 104, and selects the output tile 128 corresponding to the identified viewpoint.

In some examples, the video selection circuitry 102 switches the output tile 128 and/or the video streams 118 to be presented in response to a change in the selected viewpoint. For example, in response to the video selection circuitry 102 determining, based on the user input data 126 and/or the camera stream 130, that a new selected viewpoint is to be presented in the immersive video 124, the video selection circuitry 102 selects a different one of the tiles 122 corresponding to the new selected viewpoint from the subset 119 of the video streams 118. Additionally or alternatively, when the new selected viewpoint is not represented in any of the tiles 122 included in the subset 119 of the video streams 118, the video selection circuitry 102 can switch one or more of the video streams 118A, 118B, 118C included in the subset 119 with different one(s) of the video streams 118 available from the server 108. For example, the video selection circuitry 102 identifies and/or selects one of the video streams 118 from the server 108 that corresponds to the new selected viewpoint. In some examples, the video selection circuitry 102 accesses the selected one of the video streams 118 from the server 108 and/or updates the subset 119 to include the selected one of the video streams 118. In some such examples, the video selection circuitry 102 halts access to one or more of the video streams 118A, 118B, 118C presently included in the subset 119 as a result of accessing the selected one of the video streams 118 from the server 108.

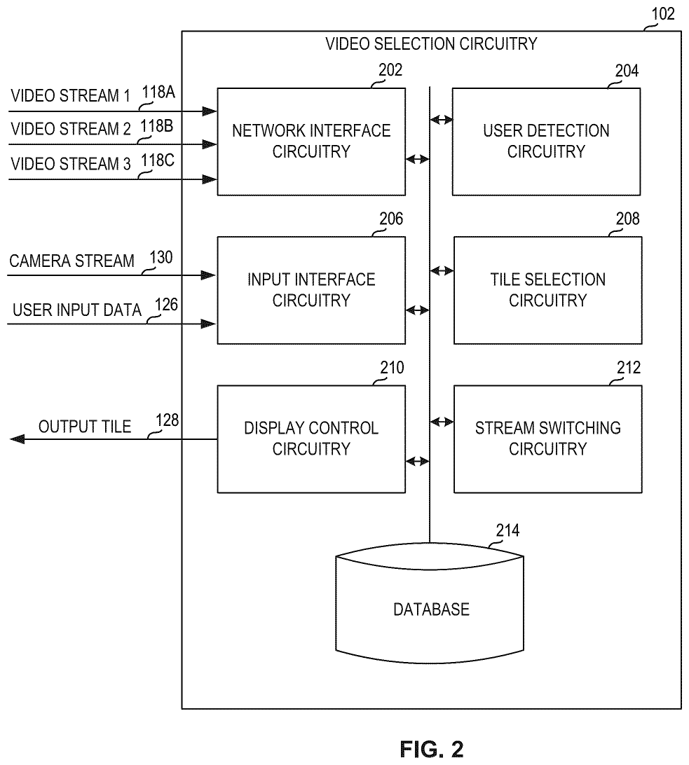

FIG. 2 is a block diagram of the example video selection circuitry 102 of FIG. 1. The video selection circuitry 102 of FIG. 2 may be instantiated (e.g., creating an instance of, bring into being for any length of time, materialize, implement, etc.) by processor circuitry such as a central processing unit executing instructions. Additionally or alternatively, the video selection circuitry 102 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

In the illustrated example of FIG. 2, the video selection circuitry 102 includes example network interface circuitry 202, example user detection circuitry 204, example input interface circuitry 206, example tile selection circuitry 208, example display control circuitry 210, example stream switching circuitry 212, and an example database 214.

The example database 214 stores data utilized and/or obtained by the video selection circuitry 102. The example database 214 of FIG. 2 is implemented by any memory, storage device and/or storage disc for storing data such as, for example, flash memory, magnetic media, optical media, solid state memory, hard drive(s), thumb drive(s), etc. Furthermore, the data stored in the example database 214 may be in any data format such as, for example, binary data, comma delimited data, tab delimited data, structured query language (SQL) structures, etc. While, in the illustrated example, the example database 214 is illustrated as a single device, the example database 214 and/or any other data storage devices described herein may be implemented by any number and/or type(s) of memories.

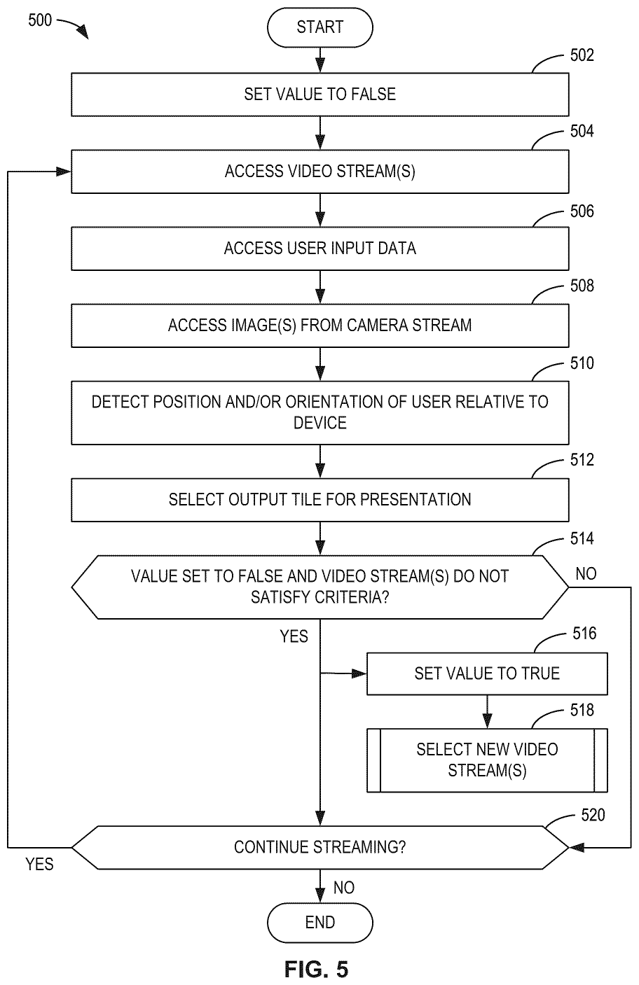

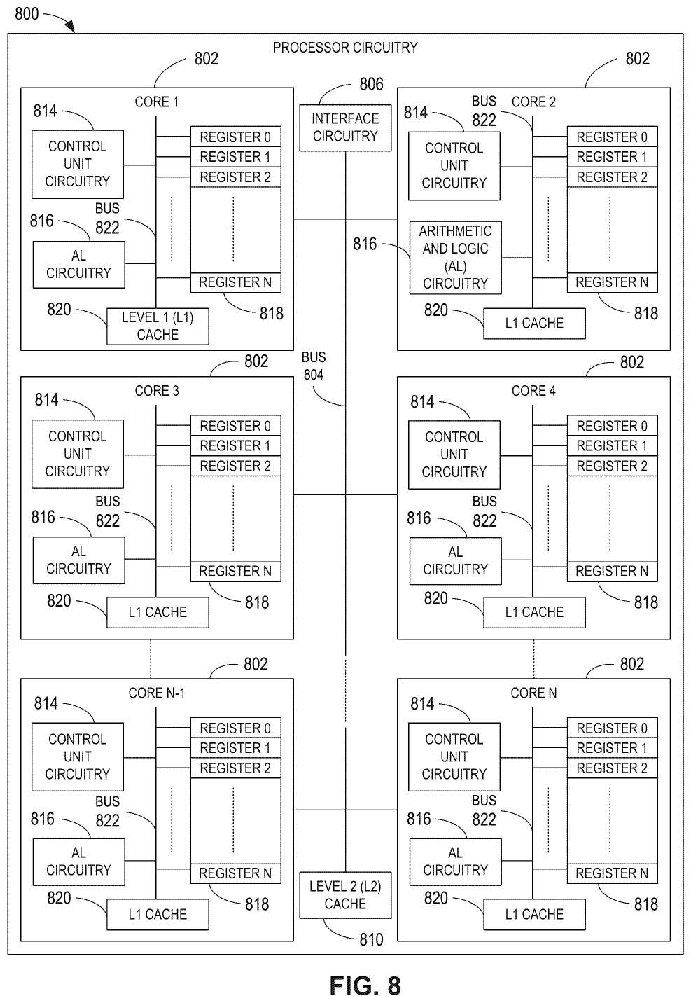

The example network interface circuitry 202 of FIG. 2 obtains and/or provides network communications via the example network 110 of FIG. 8. In this example, the network interface circuitry 202 obtains the example subset 119 of the video streams 118 from the example server 108 of FIG. 1, including the first example video stream 118A, the second example video stream 118B, and/or the third example video stream 118C. In some examples, the network interface circuitry 202 accesses and/or obtains the video streams 118 in response to one or more requests sent to the server 108, where the requests indicate one(s) of the video streams 118 to be accessed. In some examples, the network interface circuitry 202 halts access to one or more of the video streams 118 based on a selection by the stream switching circuitry 212. In some examples, the network interface circuitry 202 is instantiated by programmable circuitry executing network interface circuitry instructions and/or configured to perform operations such as those represented by the flowcharts of FIGS. 5 and/or 6.

The example input interface circuitry 206 obtains and/or access input data provided via the device 106 and/or the camera 114 of FIG. 1. For example, the input interface circuitry 206 accesses the example camera stream 130 from the camera 114, where the camera stream 130 includes one or more images of the user 104 of FIG. 1 captured by the camera 114. Additionally or alternatively, the input interface circuitry 206 obtains the example user input data 126 provided by the user 104 via one or more input devices (e.g., a mouse, a keyboard, etc.) operatively coupled to the device 106 of FIG. 1. In some examples, the user input data 126 indicates a selection of one or more viewpoints of the immersive video 124 based on adjustment of a slider presented by the browser 116 of FIG. 1, interaction with (e.g., clicking, hovering, and/or dragging) the immersive video 124 via the mouse, pressing of one or more keys of the keyboard, etc. In some examples, the input interface circuitry 206 is instantiated by programmable circuitry executing input interface circuitry instructions and/or configured to perform operations such as those represented by the flowcharts of FIGS. 5 and/or 6.

The example user detection circuitry 204 analyzes one or more images from the camera stream 130 to determine a position and/or an orientation (e.g., a yaw angle, a pitch angle, and/or a roll angle) of the user 104 with respect to the camera 114 of FIG. 1. In some examples, the example user detection circuitry 204 implements one or more image processing techniques and/or machine learning models to detect a face of the user 104 in the images. The user detection circuitry 204 extracts one or more facial reference features from the detected face in the images as a reference marker for determining the orientation of the face of the user 104. For example, the user detection circuitry 204 may identify a nose of the user 104 as the facial reference feature for the face orientation analysis. In other examples, the facial reference feature can include a nose bridge, a right eye, a left eye, a chin, etc. of the user 104. In some examples, the user detection circuitry 204 executes one or more neural network models to predict an angle at which the facial feature is disposed relative to the camera 114 based on the images. For example, as a result of execution of the neural network model(s), the user detection circuitry 204 determines a yaw angle, a pitch angle, and/or a roll angle between the user 104 and the camera 114.

In some examples, the neural network model(s) are trained by the user detection circuitry 204 using training image data showing users with their heads and, thus, facial features such as the nose, eyes, chin, in different orientations (e.g., head turned upward, head turned to the left, etc.). The training image data can indicate the angles (e.g., yaw angles, pitch angles, and/or roll angles) at which the facial features of the users are disposed. In some examples, during training of the neural network model(s), the user detection circuitry 204 determines relative distances between two or more facial features (e.g., the nose and the chin). In such examples, the user detection circuitry 204 determines correlations between the relative distances and labeled angles of the facial features. In some examples, the user detection circuitry 204 trains the neural network model(s) based on the correlations such that, when executed, the neural network model(s) output angles based on distances between the facial features identified in the images from the camera stream 130. In some examples, the user detection circuitry 204 is instantiated by programmable circuitry executing user detection circuitry instructions and/or configured to perform operations such as those represented by the flowcharts of FIGS. 5 and/or 6.

The example tile selection circuitry 208 of FIG. 2 selects one(s) of the example tiles 122 of the video streams 118 of FIG. 1 to be presented to the user 104 via the device 106. In particular, the tile selection circuitry 208 selects the output tile 128 to be provided to the browser 116 and displayed on the display 112 of the device 106 to produce the immersive video 124 of FIG. 1. In some examples, the tile selection circuitry 208 selects the output tile 128 from ones of the tiles 122 included in the subset 119 of the video streams 118 accessed and/or retrieved from the server 108 of FIG. 1. In some examples, the tile selection circuitry 208 identifies a selected viewpoint indicated in the user input data 126 obtained by the input interface circuitry 206. Additionally or alternatively, the tile selection circuitry 208 identifies the selected viewpoint based on the position and/or orientation of the user 104 determined by the user detection circuitry 204. As a result of identifying the selected viewpoint, the tile selection circuitry 208 selects the output tile 128 corresponding to the selected viewpoint. In some examples, in response to determining that the selected viewpoint is not represented in the ones of the tiles 122 included in the subset 119 of the video streams 118, the tile selection circuitry 208 directs the stream switching circuitry 212 to access a different one of the video streams 118 from the server 108, where the one of the video streams 118 includes one of the tiles 122 corresponding to the selected viewpoint. In some examples, the tile selection circuitry 208 is instantiated by programmable circuitry executing tile selection circuitry instructions and/or configured to perform operations such as those represented by the flowcharts of FIGS. 5 and/or 6.

The example display control circuitry 210 causes presentation and/or display of the output tile 128 to produce the example immersive video 124 of FIG. 1. In the example of FIG. 2, the display control circuitry 210 provides the output tile 128 to the browser 116 of the device 106, and the browser 116 causes the output tile 128 to be displayed on a web page presented to the user 104. In some examples, the display control circuitry 210 processes the output tile 128 prior to presentation thereof. For example, the display control circuitry 210 can execute one or more image processing algorithms to modify a resolution of the output tile 128, adjust lighting and/or color in the output tile 128, crop a portion of the output tile 128, etc. In some examples, the display control circuitry 210 is instantiated by programmable circuitry executing display control circuitry instructions and/or configured to perform operations such as those represented by the flowcharts of FIGS. 5 and/or 6.

The example stream switching circuitry 212 of FIG. 2 switches and/or selects one(s) of the video streams 118 to be accessed and/or obtained from the server 108 of FIG. 1. For example, the stream switching circuitry 212 selects the one(s) of the video streams 118 to be included in the subset 119 provided to the video selection circuitry 102. In some examples, the stream switching circuitry 212 selects default one(s) of the video streams 118 to be included in the subset 119 upon initialization of a web page accessed by the browser 116. In some examples, the stream switching circuitry 212 selects the one(s) of the video streams 118 based on the selected output tile 128 and/or one or more criteria (e.g., rules, heuristics) for video stream selection. For example, the stream switching circuitry 212 selects, from the video streams 118 available from the server 108, an active video stream including the selected output tile 128. Further, the stream switching circuitry 212 selects, from the video streams 118 available from the server 108, one or more inactive (e.g., background) video streams satisfying the criteria.

In some examples, the stream switching circuitry 212 can select the inactive video streams including ones of the tiles 122 that are in a neighborhood of the selected output tile 128. In some examples, the neighborhood is based on the sequence of tile numbers assigned to the tiles 122. For example, the neighborhood of the output tile 128 can include one or more of the tiles 122 preceding the output tile 128 in the sequence and/or one or more of the tiles 122 following the output tile 128 in the sequence. In some examples, the stream switching circuitry 212 selects the inactive video streams based on a sequence of the stream numbers assigned to the video streams 118. For example, the stream switching circuitry 212 can select one or more of the video streams 118 preceding the active video stream and/or one or more of the video streams 118 subsequent to the active video stream in the sequence of stream numbers. In some examples, the stream switching circuitry 212 directs the network interface circuitry 202 to access and/or obtain the selected active and inactive video streams from the server 108.

In some examples, the stream switching circuitry 212 switches one or more of the active and inactive video streams included in the subset 119 of video streams 118 based on a change in the selected viewpoint of the immersive video 124. For example, in response to the tile selection circuitry 208 selecting a new output tile 128 from the one(s) of the video streams 118 included in the subset 119, the stream switching circuitry 212 identifies a new active video stream corresponding to the selected output tile 128. In such examples, the stream switching circuitry 212 determines whether the inactive video streams in the subset 119 satisfy the criteria. For example, the stream switching circuitry 212 determines whether the inactive video streams include one or more of the tiles 122 in a neighborhood of the selected output tile 128, and/or whether the inactive video streams directly precede or are subsequent to the active video stream in the sequence of stream numbers.

In some examples, in response to determining that one or more of the inactive video streams does not satisfy the criteria, the stream switching circuitry 212 directs the network interface circuitry 202 to halt and/or stop access to the one or more inactive video streams. Further, the stream switching circuitry 212 selects one or more new inactive video streams available from the server 108 that satisfy the criteria, and directs the network interface circuitry 202 to access and/or retrieve the new inactive video streams from the server 108. In some examples, the stream switching circuitry 212 is instantiated by programmable circuitry executing stream switching circuitry instructions and/or configured to perform operations such as those represented by the flowcharts of FIGS. 5 and/or 6.

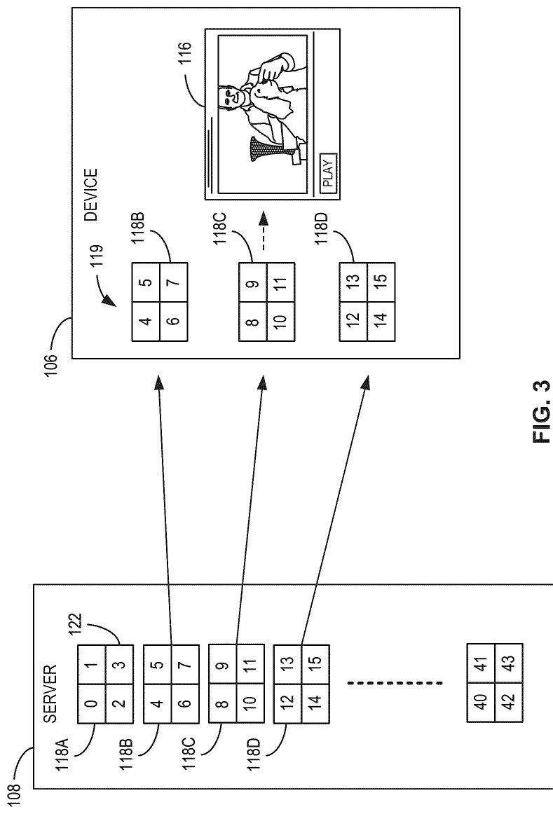

FIG. 3 illustrates selection of the example subset 119 of the video streams 118 to be provided to the example device 106 from the example server 108 of FIG. 1. In the illustrated example of FIG. 3, the server 108 includes and/or stores the example video streams 118 representative of a scene. In this example, the server 108 includes eleven of the video streams 118 each including four of the tiles 122, such that the video streams 118 represent a total of 44 different viewpoints of the scene. In the example of FIG. 3, the tiles 122 are assigned tile numbers from 0 to 43, where a first example video stream 118A includes ones of the tiles 122 corresponding to tile numbers 0 to 3, a second example video stream 118B includes ones of the tiles 122 corresponding to tile numbers 4 to 7, a third example video stream 118C includes ones of the tiles 122 corresponding to tile numbers 8 to 11, a fourth example video stream 118D includes ones of the tiles 122 corresponding to tile numbers 12 to 15, etc. In this example, each of the video streams 118 has a resolution of 2560×1440 pixels. Further, the tiles 122 for a given frame number are synchronized across the video streams 118, such that the tiles 122 are representative of the scene from different viewpoints but at a same point in time.

In the example of FIG. 3, the video selection circuitry 102 of FIGS. 1 and/or 2 selects the subset 119 of the video streams 118 to be accessed by the device 106. In this example, based on a bandwidth available for the browser 116, the device 106 can access three of the video streams 118 at a time. In some examples, a different number (e.g., two, four, five, etc.) of the video streams 118 can be included in the subset 119. In the illustrated example, the video selection circuitry 102 determines that the viewpoint selected by the user 104 of FIG. 1 corresponds to one of the tiles 122 corresponding to tile number 10. Accordingly, the video selection circuitry 102 selects the third video stream 118C including tile number 10 as the active video stream to be included in the subset 119.

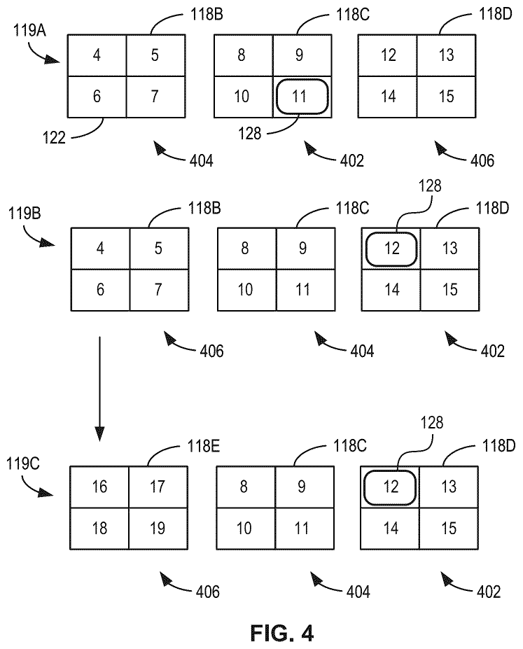

In the illustrated example of FIG. 3, the video selection circuitry 102 selects the second and fourth video streams 118B, 118D as the inactive video streams to be included in the subset 119. In some examples, the video selection circuitry 102 selects the inactive video streams based on the sequence of tile numbers and/or stream numbers across the video streams 118. For example, the video selection circuitry 102 selects the second video stream 118B as a first inactive video stream in response to determining that the tile numbers of the second video stream 118B precede (e.g., directly precede) the tile numbers of the active video stream (e.g., the third video stream 118C). Similarly, the video selection circuitry 102 selects the fourth video stream 118D as a second inactive video stream in response to determining that the tile numbers of the fourth video stream 118D are subsequent to the tile numbers of the active video stream. In some examples, as described in connection with FIG. 4 below, the video selection circuitry 102 switches one or more of the active and inactive video streams in response to a change in the selected viewpoint.

FIG. 4 illustrates switching and/or selection of an example active video stream 402 and example inactive video streams 404, 406 from the example video streams 118 of FIGS. 1 and/or 3. In the illustrated example of FIG. 4, the video selection circuitry 102 of FIGS. 1 and/or 2 determines that a selected viewpoint of the example immersive video 124 of FIG. 1 corresponds to tile number 11 in the sequence of the example tiles 122. Accordingly, the video selection circuitry 102 selects tile number 11 as the output tile 128, and selects the third example video stream 118C as the active video stream 402. In some examples, the video selection circuitry 102 includes the third video stream 118C in a first example subset 119A provided to the example device 106 of FIGS. 1 and/or 3.

In the example of FIG. 4, the video selection circuitry 102 selects the inactive video streams 404, 406 to be included in the first subset 119A based on a neighborhood of the selected output tile 128 and/or the active video stream 402. For example, the video selection circuitry 102 selects one of the video streams 118 directly before (e.g., preceding) the active video stream 402 and one of the video streams 118 directly after (e.g., subsequent to) the active video stream 402 in the sequence of stream numbers as the inactive video streams 402, 404. In this example, in response to determining that the second video stream 118B precedes (e.g., is directly before) the active video stream 402 in the sequence of stream numbers and/or tile numbers, the video selection circuitry 102 selects the second video stream 118B as the first inactive video stream 404 in the first subset 119A. Similarly, in response to determining that the fourth video stream 118D follows (e.g., directly follows, is subsequent to) the active video stream 402 in the sequence of stream numbers and/or tile numbers, the video selection circuitry 102 selects the fourth video stream 118D as the second inactive video stream 406 in the first subset 119A. In some examples, the video selection circuitry 102 streams and/or accesses the first subset 119A and causes presentation of the output tile 128 to the user 104 of FIG. 1.

In some examples, the user 104 selects a new viewpoint of the immersive video 124 to be presented to the user 104. In this example, the video selection circuitry 102 determines that the new selected viewpoint corresponds to tile number 12 in the sequence of the example tiles 122. In such examples, the video selection circuitry 102 selects tile number 12 as the output tile 128, and switches the active video stream 402 from the third video stream 118C to the fourth video stream 118D. Thus, the second and third video streams 118B, 118C correspond to the inactive video streams 406, 404 for a second example subset 119B of FIG. 4. In some examples, because each of the video streams 118B, 118C, 118D is locally accessible by the device 106 of FIG. 1, switching between viewpoints across the video streams 118B, 118C, 118D can be performed with little or no delay.

In some examples, in response to switching the active video stream 402, the video selection circuitry 102 determines whether the active and inactive video streams 402, 404, 406 in the second subset 119B satisfy one or more criteria. For example, the video selection circuitry 102 determines whether the inactive video streams 404, 406 in the second subset 119B are in a neighborhood of the active video stream 402. In this example, the neighborhood of the active video stream 402 includes one of the video streams 118 that comes before (e.g., directly before, precedes) the active video stream 402 in the sequence of stream numbers, and one of the video streams 118 that comes after (e.g., directly after, is subsequent to) the active video stream 402 in the sequence of stream numbers. Additionally or alternatively, the video selection circuitry 102 determines whether the inactive video streams 404, 406 include one or more of the tiles 122 that are in a neighborhood of the output tile 128. For example, the neighborhood of the output tiles 128 includes a first plurality of the tiles 122 that comes before (e.g., directly before) the output tile 128 in the sequence of tile numbers, and a second plurality of the tiles 122 that comes after (e.g., directly after, is subsequent to) the output tile 128 in the sequence of tile numbers. In some examples, one or more different criteria may be used for evaluating the inactive video streams 404, 406.

In the illustrated example of FIG. 4, for the second subset 119B, the video selection circuitry 102 determines that the first inactive video stream 404 (e.g., corresponding to the third video stream 118C) directly precedes the active video stream 402 in the sequence of stream numbers and, thus, determines that the first inactive video stream 404 satisfies the criteria. Further, in this example, the video selection circuitry 102 determines that the second inactive video stream 406 (e.g., corresponding to the second video stream 118B) does not satisfy the criteria in response to determining that the second inactive video stream 406 does not directly precede or follow the active video stream 402 in the sequence of stream numbers. In such examples, the video selection circuitry 102 determines that a different one of the video streams 118 is to be selected as the second inactive video stream 406.

In the illustrated example of FIG. 4, the video selection circuitry 102 halts access to the second video stream 118B, and selects and/or accesses a new one of the video streams 118 available at the server 108 of FIG. 1. In this example, the video selection circuitry 102 selects a fifth example video stream 118E to be used as the second inactive video stream 406, where the fifth video stream 118E is after (e.g., subsequent to) the active video stream 402 in the sequence of stream numbers and/or tile numbers. As such, the video selection circuitry 102 determines that a third example subset 119C accessed by the device 106 satisfies the criteria, where the third subset 119C includes the fourth video stream 118D as the active video stream 402 and the third and fifth video streams 118C, 118E as the inactive video streams 404, 406. In this example, because the switching of the inactive video streams 404, 406 occurs while the inactive video streams 404, 406 are not being viewed by and/or presented to the user 104, delays associated with switching of the video streams 118 are unnoticed by the user 104 during presentation of the immersive video 124.

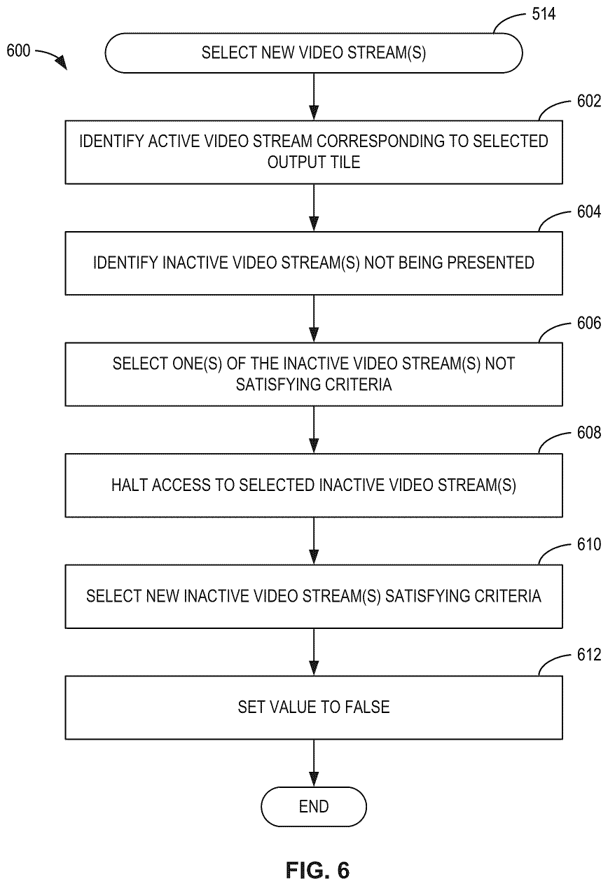

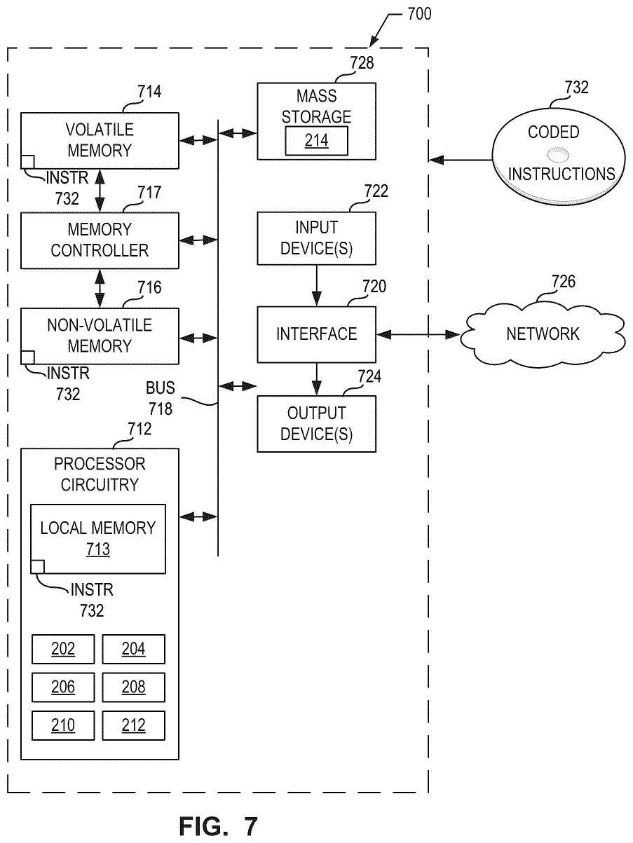

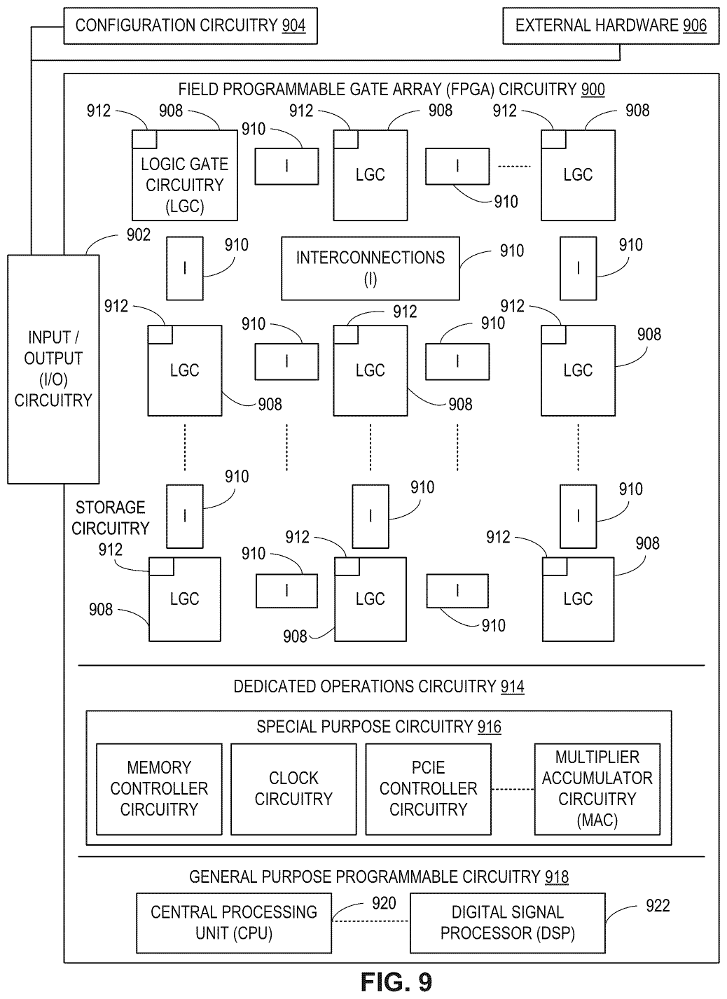

In some examples, the video selection circuitry 102 includes means for accessing video streams. For example, the means for accessing video streams may be implemented by the network interface circuitry 202. In some examples, the network interface circuitry 202 may be instantiated by programmable circuitry such as the example programmable circuitry 712 of FIG. 7. For instance, the network interface circuitry 202 may be instantiated by the example microprocessor 800 of FIG. 8 executing machine executable instructions such as those implemented by at least blocks 502, 514, 516 of FIG. 5 and/or blocks 608, 610 of FIG. 6. In some examples, network interface circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the network interface circuitry 202 may be instantiated by any other combination of hardware, software, and/or firmware. For example, the network interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the video selection circuitry 102 includes means for obtaining inputs. For example, the means for obtaining inputs may be implemented by the input interface circuitry 206. In some examples, the input interface circuitry 206 may be instantiated by programmable circuitry such as the example programmable circuitry 712 of FIG. 7. For instance, the input interface circuitry 206 may be instantiated by the example microprocessor 800 of FIG. 8 executing machine executable instructions such as those implemented by at least blocks 504, 506 of FIG. 5. In some examples, input interface circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the input interface circuitry 206 may be instantiated by any other combination of hardware, software, and/or firmware. For example, the input interface circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the video selection circuitry 102 includes means for detecting. For example, the means for detecting may be implemented by the user detection circuitry 204. In some examples, the user detection circuitry 204 may be instantiated by programmable circuitry such as the example programmable circuitry 712 of FIG. 7. For instance, the user detection circuitry 204 may be instantiated by the example microprocessor 800 of FIG. 8 executing machine executable instructions such as those implemented by at least block 508 of FIG. 5. In some examples, user detection circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the user detection circuitry 204 may be instantiated by any other combination of hardware, software, and/or firmware. For example, the user detection circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the video selection circuitry 102 includes means for selecting. For example, the means for selecting may be implemented by the tile selection circuitry 208. In some examples, the tile selection circuitry 208 may be instantiated by programmable circuitry such as the example programmable circuitry 712 of FIG. 7. For instance, the tile selection circuitry 208 may be instantiated by the example microprocessor 800 of FIG. 8 executing machine executable instructions such as those implemented by at least block 510 of FIG. 5. In some examples, tile selection circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the tile selection circuitry 208 may be instantiated by any other combination of hardware, software, and/or firmware. For example, the tile selection circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the video selection circuitry 102 includes means for controlling a display. For example, the means for controlling a display may be implemented by the display control circuitry 210. In some examples, the display control circuitry 210 may be instantiated by programmable circuitry such as the example programmable circuitry 712 of FIG. 7. For instance, the display control circuitry 210 may be instantiated by the example microprocessor 800 of FIG. 8 executing machine executable instructions such as those implemented by at least block 510 of FIG. 5. In some examples, display control circuitry 210 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the display control circuitry 210 may be instantiated by any other combination of hardware, software, and/or firmware. For example, the display control circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the video selection circuitry 102 includes means for switching. For example, the means for switching may be implemented by the stream switching circuitry 212. In some examples, the stream switching circuitry 212 may be instantiated by programmable circuitry such as the example programmable circuitry 712 of FIG. 7. For instance, the stream switching circuitry 212 may be instantiated by the example microprocessor 800 of FIG. 8 executing machine executable instructions such as those implemented by at least blocks 512, 514 of FIG. 5 and/or blocks 602, 604, 606, 608, 610 of FIG. 6. In some examples, stream switching circuitry 212 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the stream switching circuitry 212 may be instantiated by any other combination of hardware, software, and/or firmware. For example, the stream switching circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the video selection circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example network interface circuitry 202, the example user detection circuitry 204, the example input interface circuitry 206, the example tile selection circuitry 208, the example display control circuitry 210, the example stream switching circuitry 212, the example database 214, and/or, more generally, the example video selection circuitry 102 of FIG. 2, may be implemented by hardware alone or by hardware in combination with software and/or firmware. Thus, for example, any of the example network interface circuitry 202, the example user detection circuitry 204, the example input interface circuitry 206, the example tile selection circuitry 208, the example display control circuitry 210, the example stream switching circuitry 212, the example database 214, and/or, more generally, the example video selection circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example video selection circuitry 102 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the video selection circuitry 102 of FIG. 2 and/or representative of example operations which may be performed by programmable circuitry to implement and/or instantiate the video selection circuitry 102 of FIG. 2, are shown in FIGS. 5 and/or 6. The machine readable instructions may be one or more executable programs or portion(s) of one or more executable programs for execution by programmable circuitry such as the processor circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5 and/or 6, many other methods of implementing the example video selection circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5 and/or 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed, instantiated, and/or performed by programmable circuitry to implement the example video selection circuitry 102 of FIGS. 1 and/or 2. The example machine-readable instructions and/or the example operations 500 of FIG. 5 begin at block 502, at which the example video selection circuitry 102 sets a value (e.g., a flag value) to false. For example, the value can be stored in the example database 214 of FIG. 2, and the example stream switching circuitry 212 of FIG. 2 updates the value based on whether a stream switching process is being performed. In some examples, the value corresponds to a first value (e.g., 1 and/or true) when the stream switching circuitry 212 is performing a stream switching process, and the value corresponds to a second value (e.g., 0 and/or false) when the stream switching circuitry 212 is not performing a stream switching process.

At block 504, the example method 500 includes accessing one or more of the example video streams 118 of FIG. 1. For example, the example network interface circuitry 202 of FIG. 2 accesses and/or obtains, from the example server 108 of FIG. 1, the ones of the video streams 118 included in the example subset 119 of FIG. 1. In this example, the subset 119 includes the first, second, and third example video streams 118A, 118B, 118C. In some examples, the subset 119 includes a different number and/or combination of the video streams 118 from the server 108.

At block 506, the example method 500 includes accessing the example user input data 126 of FIG. 1. For example, the example input interface circuitry 206 of FIG. 2 accesses and/or obtains the user input data 126 provided to the example device 106 of FIG. 1 from the user 104. In some examples, the user input data 126 indicates a selection of one or more viewpoints of the example immersive video 124 of FIG. 1 based on adjustment of a slider presented by the example browser 116 of FIG. 1, interaction with (e.g., clicking, hovering, and/or dragging) the immersive video 124 via a mouse operatively coupled to the device 106, pressing of one or more keys of a keyboard operatively coupled to the device 106, etc.

At block 508, the example method 500 includes accessing one or more images of the example camera stream 130 captured by the example camera 114 of FIG. 1. For example, the example input interface circuitry 206 accesses and/or obtains the one or more images from the camera stream 130, where the one or more images are representative of the user 104 of the device 106.

At block 510, the example method 500 includes detecting a position and/or orientation of the user 104 relative to the device 106. For example, the example user detection circuitry 204 of FIG. 2 executes, based on the image(s) from the camera stream 130, one or more image processing algorithms and/or neural network models to determine the position and/or orientation of the user 104. In some examples, the position and/or orientation includes at least one of a yaw angle, a pitch angle, and/or a roll angle of one or more facial features of the user 104 relative to the device 106.

At block 512, the example method 500 includes selecting the example output tile 128 of FIG. 1 for presentation to the user 104. For example, the tile selection circuitry 208 determines, based on the user input data 126 and/or the detected position and/or orientation of the user 104, a viewpoint of the immersive video 124 to be displayed. Further, the tile selection circuitry 208 selects the output tile 128 corresponding to the viewpoint from among the ones of the tiles 122 included in the subset 119 of the video streams 118. In some examples, the tile selection circuitry 208 directs the example display control circuitry 210 to present the selected output tile 128 to the user 104 via the device 106 and/or the browser 116 of FIG. 1.

At block 514, the example method 500 includes determining whether the value (e.g., the flag value) stored in the database 214 is set to false and the video streams 118A, 118B, 118C included in the example subset 119 do not satisfy one or more criteria. For example, the example stream switching circuitry 212 identifies one of the video streams 118A, 118B, 118C that includes the selected output tile 128 as an active video stream, and identifies the remaining ones of the video streams 118A, 118B, 118C as inactive video streams. In some examples, the stream switching circuitry 212 determines whether one(s) of the inactive video streams satisfy the criteria based on whether the inactive video streams are in a neighborhood of the active video stream and/or whether the ones of the tiles 122 included in the inactive video streams are in a neighborhood of the output tile 128. Further, the stream switching circuitry 212 obtains the value stored in the database 214, and determines whether the value corresponds to false (e.g., 0). In response to the stream switching circuitry 212 determining that the value is set to false and the video streams 118A, 118B, 118C do not satisfy the criteria (e.g., block 514 returns a result of YES), control proceeds to blocks 516 and 520. Alternatively, in response to the stream switching circuitry 212 determining that at least one of (a) the value is set to true or (b) the video streams 118A, 118B, 118C satisfy the criteria (e.g., block 514 returns a result of NO), control proceeds to block 520.

At block 516, the example method 500 includes setting the value to true. For example, the stream switching circuitry 212 updates the value stored in the database 214 of FIG. 2 to be true (e.g., 1) to indicate that a stream switching process is being performed.

At block 518, the example method 500 includes selecting one or more new video streams 118 to be included in the example subset 119 of FIG. 1. For example, the stream switching circuitry 212 selects the one or more new video streams 118 that are available from the server 108 of FIG. 1 and that satisfy the one or more criteria. Selection of the one or more new video streams 118 is described further in detail below in connection with FIG. 6. In some examples, control proceeds to block 520 during the selection of the one or more new video streams 118 at block 518.

At block 520, the example method 500 includes determining whether to continue streaming the video streams 118. For example, the example network interface circuitry 202 determines whether to continue streaming based on whether the video streams 118 are available from the server 108 and/or whether the user 104 navigates to a different web page via the browser 116. In response to the network interface circuitry 202 determining to continue streaming (e.g., block 520 returns a result of YES), control returns to block 504. Alternatively, in response to the network interface circuitry 202 determining not to continue streaming (e.g., block 520 returns a result of NO), control ends.

FIG. 6 is a flowchart representative of example machine readable instructions and/or example operations 600 that may be executed, instantiated, and/or performed by programmable circuitry to implement the example video selection circuitry 102 of FIGS. 1 and/or 2 to select one or more new video streams in connection with block 518 of FIG. 5. In some examples, the example machine-readable instructions and/or the example operations 600 of FIG. 6 may be executed concurrently (e.g., in parallel) with the example instructions 500 of FIG. 5. The example machine-readable instructions and/or the example operations 600 of FIG. 6 begin at block 602, at which the example stream switching circuitry 212 of FIG. 2 identifies an active video stream corresponding to the selected example output tile 128 of FIG. 1. For example, the stream switching circuitry 212 determines that the first video stream 118A of FIG. 1 includes the selected output tile 128 and, thus, identifies the first video stream 118A as the active video stream.

At block 604, the example method 600 includes identifying one or more inactive video streams not being presented by the example device 106 of FIG. 1. For example, the stream switching circuitry 212 selects the one(s) of the video streams 118 included in the subset 119 that do not include the output tile 128 (e.g., the second and third video streams 118B, 118C), and identifies the one(s) of the video streams 118 as the inactive video streams.

At block 606, the example method 600 includes selecting one or more of the inactive video streams not satisfying the criteria. For example, for each of the inactive video streams, the stream switching circuitry 212 determines whether the inactive video stream is in a neighborhood of the active video stream and/or whether the inactive video stream includes one or more of the tiles 122 that are in a neighborhood of the output tile 128. In some examples, the stream switching circuitry 212 determines that the second video stream 118B satisfies the criteria in response to determining that the second video stream 118B directly precedes or is subsequent to the active video stream in a sequence of stream numbers assigned to the video streams 118. In some examples, the stream switching circuitry 212 determines that the third video stream 118C does not satisfy the criteria in response to determining that the third video stream 118C does not directly precede or is not subsequent to the active video stream in the sequence of stream numbers. In such examples, the stream switching circuitry 212 selects the third video stream 118C as the one of the inactive video streams not satisfying the criteria.

At block 608, the example method 600 includes halting access to the selected inactive video stream(s). For example, the stream switching circuitry 212 directs the example network interface circuitry 202 to halt access to the third video stream 118C corresponding to the selected inactive video stream.

At block 610, the example method 600 includes selecting one or more new inactive video streams from the video streams 118 that satisfy the criteria. For example, the stream switching circuitry 212 selects one of the video streams 118 accessible from the example server 108 of FIG. 1 that satisfies the criteria (e.g., is in a neighborhood of the active video stream and/or the output tile 128). In some examples, the stream switching circuitry 212 selects a fourth example video stream 118D to be included in the subset 119 of the video streams 118, and directs the network interface circuitry 202 to access the fourth video stream 118D from the server 108.

At block 612, the example method 600 includes setting the example value stored in the example database 214 of FIG. 2 to false. For example, the stream switching circuitry 212 updates the value stored in the database 214 to be false (e.g., 0) to indicate that a stream switching process is no longer being performed.

FIG. 7 is a block diagram of an example programmable circuitry platform 700 structured to execute and/or instantiate the example machine-readable instructions and/or the example operations of FIGS. 5 and/or 6 to implement the video selection circuitry 102 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example network interface circuitry 202, the example user detection circuitry 204, the example input interface circuitry 206, the example tile selection circuitry 208, the example display control circuitry 210, and the example stream switching circuitry 212.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 5 and/or 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 5 and/or 6 to effectively instantiate the circuitry of FIG. 2 as logic circuits to perform operations corresponding to those machine readable instructions. In some such examples, the circuitry of FIG. video selection circuitry 102 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5 and/or 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 5 and/or 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5 and/or 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5 and/or 6. As such, the FPGA circuitry 900 may be configured and/or structured to effectively instantiate some or all of the operations/functions corresponding to the machine readable instructions of the flowchart(s) of FIGS. 5 and/or 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 5 and/or 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 5 and/or 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 5 and/or 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 5 and/or 8, and/or an ASIC may be configured and/or structured to perform third operation(s)/function(s) corresponding to a third portion of the machine readable instructions represented by the flowcharts of FIGS. 5 and/or 6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

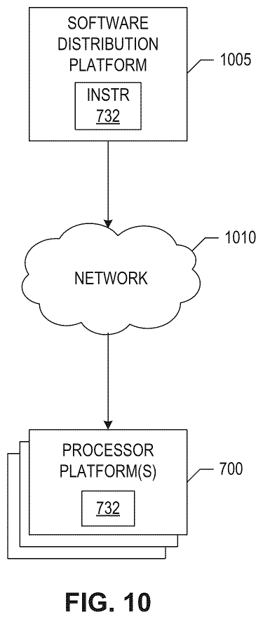

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 5 and/or 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 5 and/or 8, may be downloaded to the example programmable circuitry platform 700, which is to execute the machine readable instructions 732 to implement the video selection circuitry 102. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that produce immersive videos using a hybrid switching and tiling technique. Examples disclosed herein access and/or switch between multiple tiled video streams available at a device from a server, where the video streams include multiple tiles representative of a scene from different viewpoints. By switching between the multiple video streams available at the device level, examples disclosed herein reduce lagging and/or freezing of immersive videos presented on the device. Further, examples disclosed herein enable switching of video streams at the server level when the video streams are not being viewed by a user, thus preventing and/or reducing disruptions in the presented video. Additionally, examples disclosed herein divide multiple HD tiles across the multiple video streams, such that less bandwidth is utilized to access individual one(s) of the video streams (e.g., compared to combining the tiles in a single video stream). Thus, disclosed systems, apparatus, articles of manufacture, and methods improve the efficiency of using a computing device by reducing bandwidth utilization for streaming HD immersive videos via the Internet. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to produce immersive videos are disclosed herein. Further examples and combinations thereof include the following:

Example 1 includes an apparatus comprising memory, instructions, and programmable circuitry to at least one of execute or instantiate the instructions to access a first video stream corresponding to a scene, the first video stream including a first video frame, the first video frame including a first tile representative of the scene from a first viewpoint and a second tile representative of the scene from a second viewpoint, the second viewpoint different from the first viewpoint, access a second video stream corresponding to the scene, the second video stream synchronized with the first video stream, the first video stream including a second video frame, the second video frame including a third tile representative of the scene from a third viewpoint and a fourth tile representative of the scene from a fourth viewpoint, the fourth viewpoint different from the third viewpoint, and select at least one of the first tile, the second tile, the third tile, or the fourth tile for presentation by a device.

Example 2 includes the apparatus of example 1, wherein the programmable circuitry is to select the at least one of the first tile, the second tile, the third tile, or the fourth tile based on user input.

Example 3 includes the apparatus of example 1, wherein the programmable circuitry is to detect, based on image data, at least one of a position or an orientation of a user of the device, and select the at least one of the first tile, the second tile, the third tile, or the fourth tile based on the at least one of the position or the orientation.

Example 4 includes the apparatus of example 1, wherein the programmable circuitry is to select one of the first tile or the second tile for presentation by the device, in response to the selection, (a) access a third video stream different from the first video stream and the second video stream and (b) halt access to the second video stream.

Example 5 includes the apparatus of example 4, wherein the programmable circuitry is to select the third video stream from a plurality of video streams based on a sequence of tile numbers assigned to tiles included in frames of the plurality of video streams.

Example 6 includes the apparatus of example 4, wherein the programmable circuitry is to select the third video stream from a plurality of video streams based on a determination that the third video stream includes a third video frame with a fifth tile included in a neighborhood of the selected one of the first tile or the second tile, the neighborhood based on the sequence of tile numbers.

Example 7 includes the apparatus of example 1, wherein the programmable circuitry is to access the first and second video streams in response to navigation of the device to a web page via a web browser, and cause presentation of the at least one of the first tile, the second tile, the third tile, or the fourth tile in the web browser.

Example 8 includes At least one non-transitory computer readable medium comprising instructions that, when executed, cause programmable circuitry to at least access a first video stream corresponding to a scene, the first video stream including a first video frame, the first video frame including a first tile representative of the scene from a first viewpoint and a second tile representative of the scene from a second viewpoint, the second viewpoint different from the first viewpoint, access a second video stream corresponding to the scene, the second video stream synchronized with the first video stream, the first video stream including a second video frame, the second video frame including a third tile representative of the scene from a third viewpoint and a fourth tile representative of the scene from a fourth viewpoint, the fourth viewpoint different from the third viewpoint, and select at least one of the first tile, the second tile, the third tile, or the fourth tile for presentation by a device.

Example 9 includes the at least one non-transitory computer readable medium of example 8, wherein the instructions cause the programmable circuitry to select the at least one of the first tile, the second tile, the third tile, or the fourth tile based on user input.

Example 10 includes the at least one non-transitory computer readable medium of example 8, wherein the instructions cause the programmable circuitry to detect, based on image data, at least one of a position or an orientation of a user of the device, and select the at least one of the first tile, the second tile, the third tile, or the fourth tile based on the at least one of the position or the orientation.

Example 11 includes the at least one non-transitory computer readable medium of example 1, wherein the instructions cause the programmable circuitry to select one of the first tile or the second tile for presentation by the device, in response to the selection, (a) access a third video stream different from the first video stream and the second video stream and (b) halt access to the second video stream.

Example 12 includes the at least one non-transitory computer readable medium of example 11, wherein the instructions cause the programmable circuitry to select the third video stream from a plurality of video streams based on a sequence of tile numbers assigned to tiles included in frames of the plurality of video streams.

Example 13 includes the at least one non-transitory computer readable medium of example 11, wherein the instructions cause the programmable circuitry to select the third video stream from a plurality of video streams based on a determination that the third video stream includes a third video frame with a fifth tile included in a neighborhood of the selected one of the first tile or the second tile, the neighborhood based on the sequence of tile numbers.

Example 14 includes the at least one non-transitory computer readable medium of example 8, wherein the instructions cause the programmable circuitry to access the first and second video streams in response to navigation of the device to a web page via a web browser, and cause presentation of the at least one of the first tile, the second tile, the third tile, or the fourth tile in the web browser.

Example 15 includes an apparatus comprising network interface circuitry to access a plurality of video streams corresponding to a scene, respective ones of the video streams including respective pluralities of tiles representative of the scene from different viewpoints, and tile selection circuitry to select at least one of the tiles for presentation by a device.

Example 16 includes the apparatus of example 15, wherein the tile selection circuitry is to select the at least one of the tiles based on user input.

Example 17 includes the apparatus of example 15, further including user detection circuitry to detect, based on image data, at least one of a position or an orientation of a user of the device, the tile selection circuitry to select the at least one of the tiles based on the at least one of the position or the orientation.

Example 18 includes the apparatus of example 15, wherein the plurality of video streams is a first plurality of video streams, the network interface circuitry to, in response to the selection of the at least one of the tiles, (a) access a second plurality of video streams different from the first plurality of video streams and (b) halt access to the first plurality of video streams.

Example 19 includes the apparatus of example 18, further including stream selection circuitry to select the second plurality of video streams from a third plurality of video streams based on a sequence of tile numbers assigned to tiles included in frames of the third plurality of video streams, the third plurality of video streams including the first plurality of video streams and the second plurality of video streams.

Example 20 includes the apparatus of example 19, wherein the stream selection circuitry is to select the second plurality of video streams based on a determination that the second plurality of video streams includes a first one of the frames with a first one of the tiles included in a neighborhood of the selected at least one of the tiles, the neighborhood based on the sequence of tile numbers.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
memory;
instructions; and
programmable circuitry to at least one of execute or instantiate the instructions to:
access a first video stream corresponding to a scene, the first video stream including a first video frame, the first video frame including a first tile representative of the scene from a first viewpoint and a second tile representative of the scene from a second viewpoint, the second viewpoint different from the first viewpoint;
access a second video stream corresponding to the scene, the second video stream synchronized with the first video stream, the first video stream including a second video frame, the second video frame including a third tile representative of the scene from a third viewpoint and a fourth tile representative of the scene from a fourth viewpoint, the fourth viewpoint different from the third viewpoint; and
select at least one of the first tile, the second tile, the third tile, or the fourth tile for presentation by a device.

2. The apparatus of claim 1, wherein the programmable circuitry is to select the at least one of the first tile, the second tile, the third tile, or the fourth tile based on user input.

3. The apparatus of claim 1, wherein the programmable circuitry is to:
detect, based on image data, at least one of a position or an orientation of a user of the device; and
select the at least one of the first tile, the second tile, the third tile, or the fourth tile based on the at least one of the position or the orientation.

4. The apparatus of claim 1, wherein the programmable circuitry is to:
select one of the first tile or the second tile for presentation by the device; and
in response to the selection, (a) access a third video stream different from the first video stream and the second video stream and (b) halt access to the second video stream.

5. The apparatus of claim 4, wherein the programmable circuitry is to select the third video stream from a plurality of video streams based on a sequence of tile numbers assigned to tiles included in frames of the plurality of video streams.

6. The apparatus of claim 4, wherein the programmable circuitry is to select the third video stream from a plurality of video streams based on a determination that the third video stream includes a third video frame with a fifth tile included in a neighborhood of the selected one of the first tile or the second tile, the neighborhood based on a sequence of tile numbers.

7. The apparatus of claim 1, wherein the programmable circuitry is to:
access the first and second video streams in response to navigation of the device to a web page via a web browser; and
cause presentation of the at least one of the first tile, the second tile, the third tile, or the fourth tile in the web browser.

8. At least one non-transitory computer readable medium comprising instructions that, when executed, cause programmable circuitry to at least:
access a first video stream corresponding to a scene, the first video stream including a first video frame, the first video frame including a first tile representative of the scene from a first viewpoint and a second tile representative of the scene from a second viewpoint, the second viewpoint different from the first viewpoint;
access a second video stream corresponding to the scene, the second video stream synchronized with the first video stream, the first video stream including a second video frame, the second video frame including a third tile representative of the scene from a third viewpoint and a fourth tile representative of the scene from a fourth viewpoint, the fourth viewpoint different from the third viewpoint; and
select at least one of the first tile, the second tile, the third tile, or the fourth tile for presentation by a device.

9. The at least one non-transitory computer readable medium of claim 8, wherein the instructions cause the programmable circuitry to select the at least one of the first tile, the second tile, the third tile, or the fourth tile based on user input.

10. The at least one non-transitory computer readable medium of claim 8, wherein the instructions cause the programmable circuitry to:
detect, based on image data, at least one of a position or an orientation of a user of the device; and
select the at least one of the first tile, the second tile, the third tile, or the fourth tile based on the at least one of the position or the orientation.

11. The at least one non-transitory computer readable medium of claim 8, wherein the instructions cause the programmable circuitry to:
select one of the first tile or the second tile for presentation by the device; and
in response to the selection, (a) access a third video stream different from the first video stream and the second video stream and (b) halt access to the second video stream.

12. The at least one non-transitory computer readable medium of claim 11, wherein the instructions cause the programmable circuitry to select the third video stream from a plurality of video streams based on a sequence of tile numbers assigned to tiles included in frames of the plurality of video streams.

13. The at least one non-transitory computer readable medium of claim 11, wherein the instructions cause the programmable circuitry to select the third video stream from a plurality of video streams based on a determination that the third video stream includes a third video frame with a fifth tile included in a neighborhood of the selected one of the first tile or the second tile, the neighborhood based on a sequence of tile numbers.

14. The at least one non-transitory computer readable medium of claim 8, wherein the instructions cause the programmable circuitry to:
access the first and second video streams in response to navigation of the device to a web page via a web browser; and
cause presentation of the at least one of the first tile, the second tile, the third tile, or the fourth tile in the web browser.

15. An apparatus comprising:
network interface circuitry to access a plurality of video streams corresponding to a scene, respective ones of the video streams including respective pluralities of tiles representative of the scene from different viewpoints; and
tile selection circuitry to select at least one of the tiles for presentation by a device.

16. The apparatus of claim 15, wherein the tile selection circuitry is to select the at least one of the tiles based on user input.

17. The apparatus of claim 15, further including user detection circuitry to detect, based on image data, at least one of a position or an orientation of a user of the device, the tile selection circuitry to select the at least one of the tiles based on the at least one of the position or the orientation.

18. The apparatus of claim 15, wherein the plurality of video streams is a first plurality of video streams, the network interface circuitry to, in response to the selection of the at least one of the tiles, (a) access a second plurality of video streams different from the first plurality of video streams and (b) halt access to the first plurality of video streams.

19. The apparatus of claim 18, further including stream selection circuitry to select the second plurality of video streams from a third plurality of video streams based on a sequence of tile numbers assigned to tiles included in frames of the third plurality of video streams, the third plurality of video streams including the first plurality of video streams and the second plurality of video streams.

20. The apparatus of claim 19, wherein the stream selection circuitry is to select the second plurality of video streams based on a determination that the second plurality of video streams includes a first one of the frames with a first one of the tiles included in a neighborhood of the selected at least one of the tiles, the neighborhood based on the sequence of tile numbers.
